(19) United States
(12) Patent Application Publication
(10) Pub. No.: US 2007/0186166 A1
(43) Pub. Date: Aug. 9, 2007

(54) Creation and use of an electronic presentation slide that includes multimedia content

(76) Inventors: Kent R. Anderson, Westborough, MA (US); Xuefeng Cao, Mansfield, CT (US)

Correspondence Address: FISH & RICHARDSON PC, P.O. BOX 1022, MINNEAPOLIS, MN, 55440-1022, US

(21) Appl. No.: 11/348,380

(22) Filed: Feb. 6, 2006

(51) Int. Cl. G06F 3/00

(52) U.S. Cl. 715/730; 715/733

(57) ABSTRACT

In some examples, a PowerPoint slide is created that, when presented at a first location, will provide an animation that has been obtained during the presentation from a second location through the Internet. Creating the slide includes insertion an active object in the slide, the active object enabling a call to the multimedia content at the second location. The animation is expressed in Flash format, and the slide, when presented, includes interactive features for controlling the animation.

### BACKGROUND

This description relates to creation and use of an electronic presentation slide that includes multimedia content.

A slide of a PowerPoint presentation, for example, sometimes includes an animation, image, sound, or video clip that is presented when a user reaches that slide in the presentation.

### SUMMARY

Here we describe a presentation slide or slides that are created automatically, in some examples, by placing, in the slide or slides, an element that makes a call to the multimedia content (including interaction features) that is hosted centrally (for example, on another computer and accessed through the Internet). A programmed element of the slide is defined automatically in terms of a space and an aspect ratio for presentation of the multimedia content. The content exists independently of the slide; if the content is changed at the central host, the new content will be presented in the programmed element in a subsequent use of the slide.

The slide or slides are automatically configured to call and present networked digital information, for example, a file that is expressed in a common animation or interactivity format, with the digital information being configured and embedded in such a way that when the presentation slide is presented to viewers, the digital information causes the animation to be presented to the viewers.

Thus, in general, in one aspect, an electronic presentation slide is created that, when presented at a first location, will provide multimedia content obtained during the presentation from a second location through a network.

Implementations may include one or more of the following features. The network includes the Internet. The multimedia content comprises an animation. The second location comprises a central server. The electronic presentation slide is in PowerPoint format. The electronic presentation slide is created at the second location and delivered to the first location for inclusion in a slide presentation. The multimedia content is prepared for presentation prior to a time when the slide is presented at the first location. The multimedia content is prepared for presentation dynamically in response to a request from the presentation slide when the slide is being presented at the first location. Creating the slide includes embedding information in the slide that enables a call to the multimedia content at the second location. Creating the slide includes inserting an active object in the slide. The multimedia content is expressed in a Flash format. The slide can include user interactive controls that are displayed and can be invoked by a user. In some examples, the electronic slide may be prepared dynamically in response to a request from the user expressed in a form field interface.

Other aspects include the above and other features alone and in other combinations, expressed as methods, systems, apparatus, and program products and in other ways. Other advantages and features will become apparent from the following description and from the claims.

### DESCRIPTION

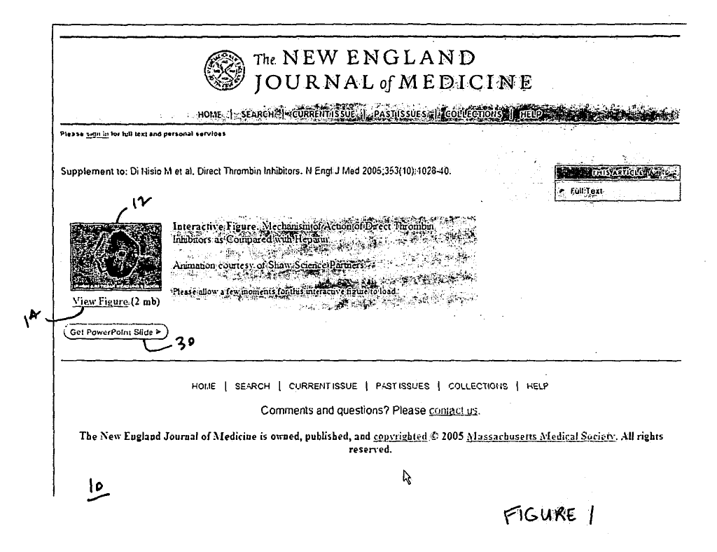

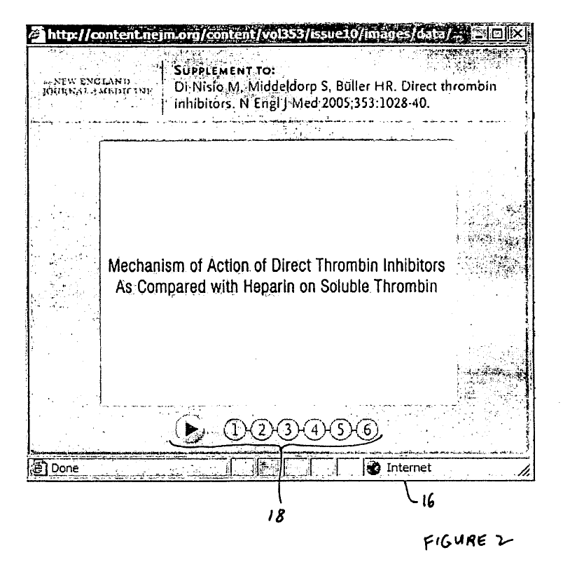

FIGS. 1 through 5 are screen shots.

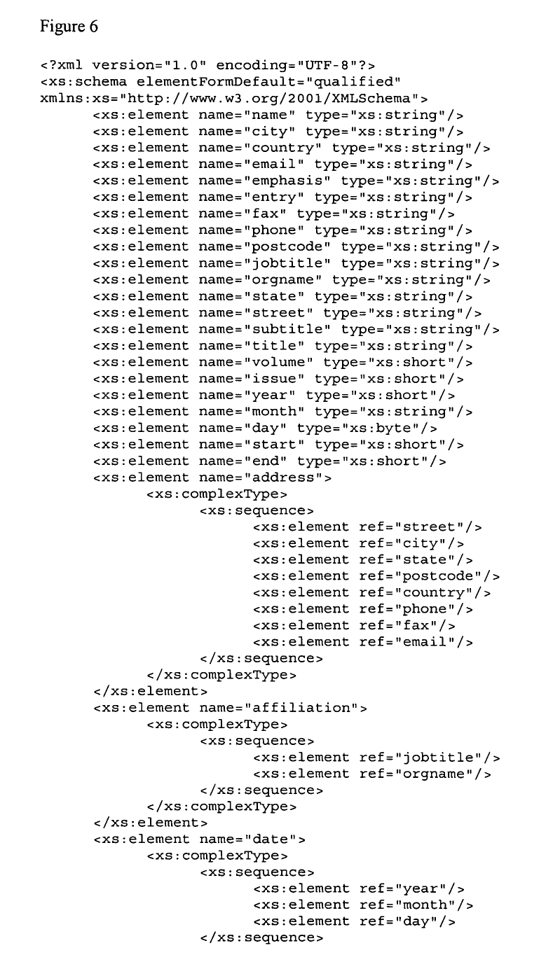

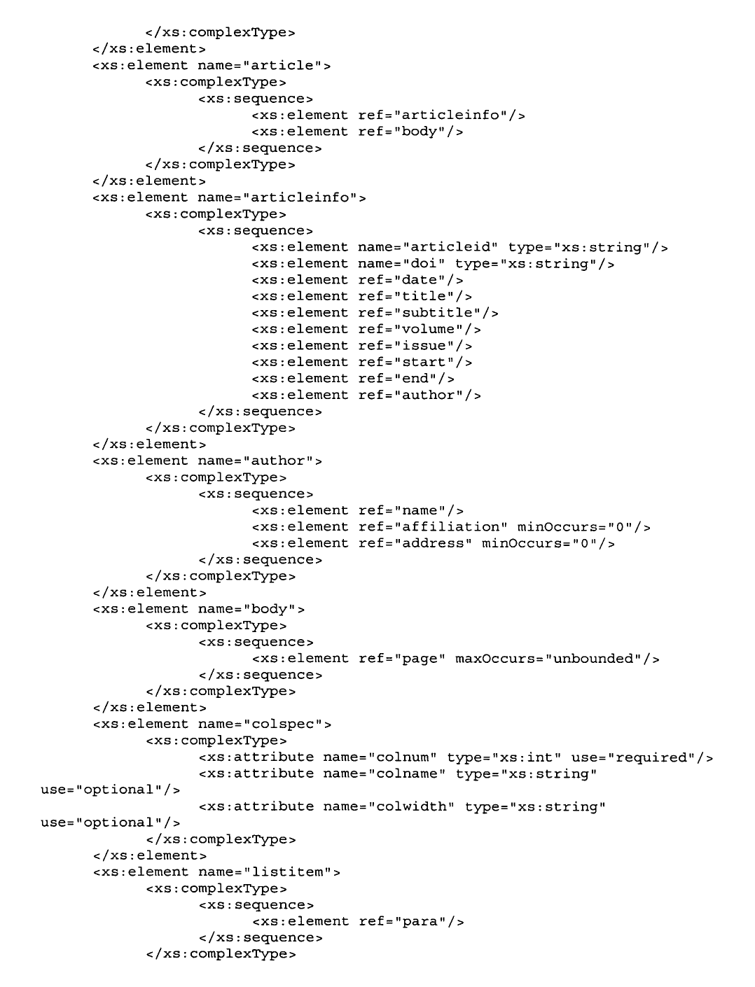

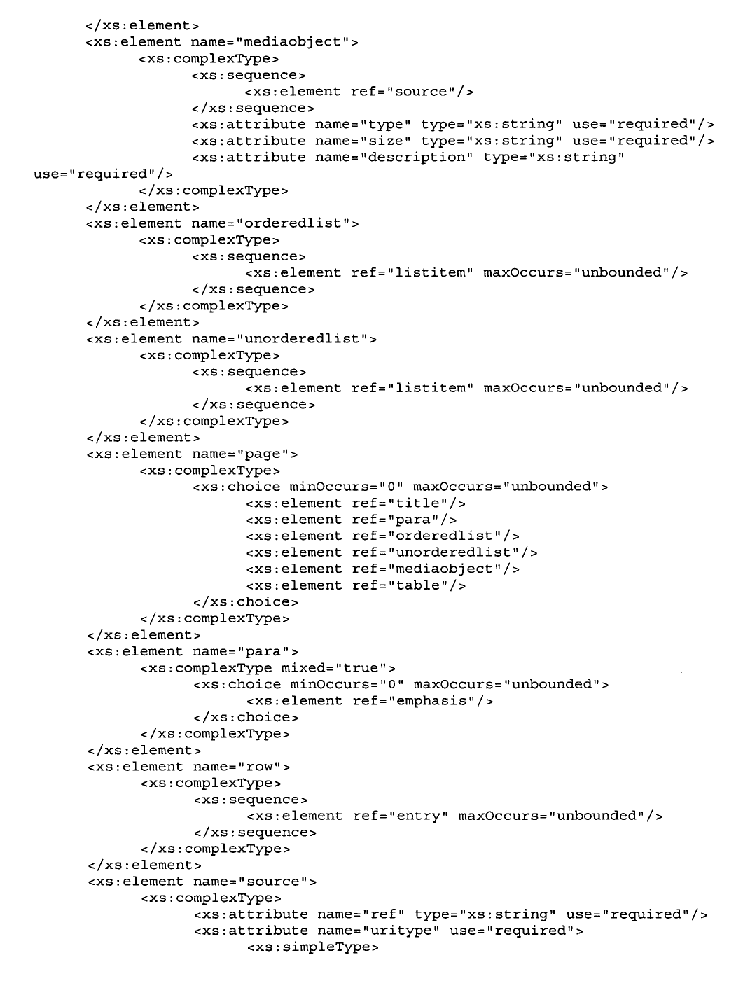

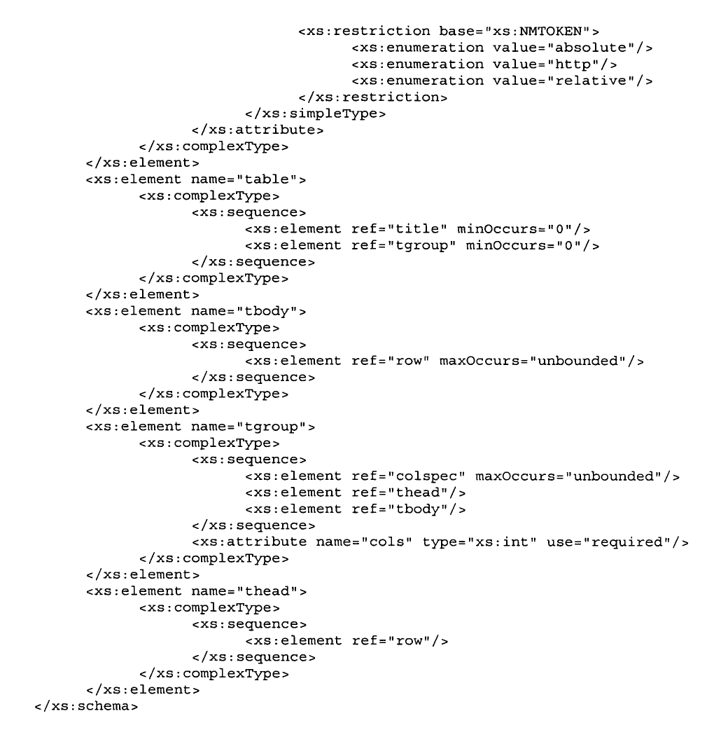

FIG. 6 shows a schema.

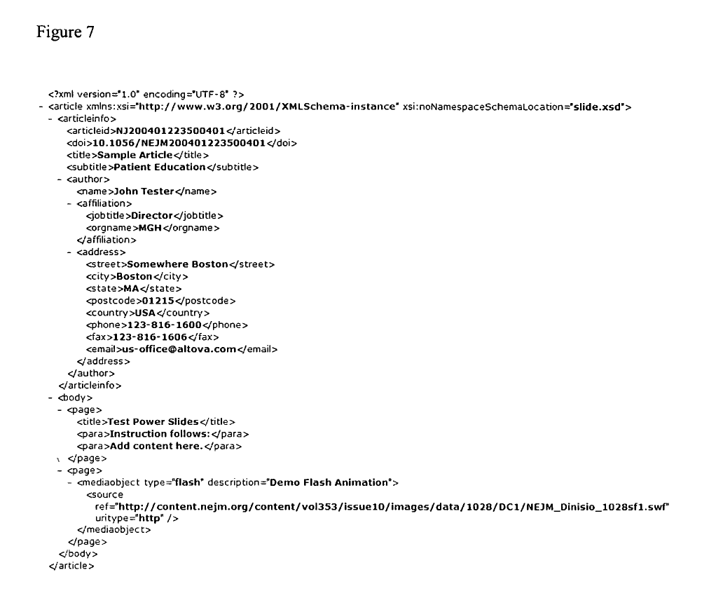

FIG. 7 shows a control file.

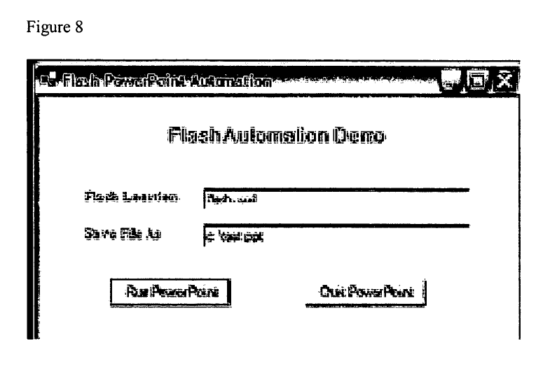

FIG. 8 shows a dialog box.

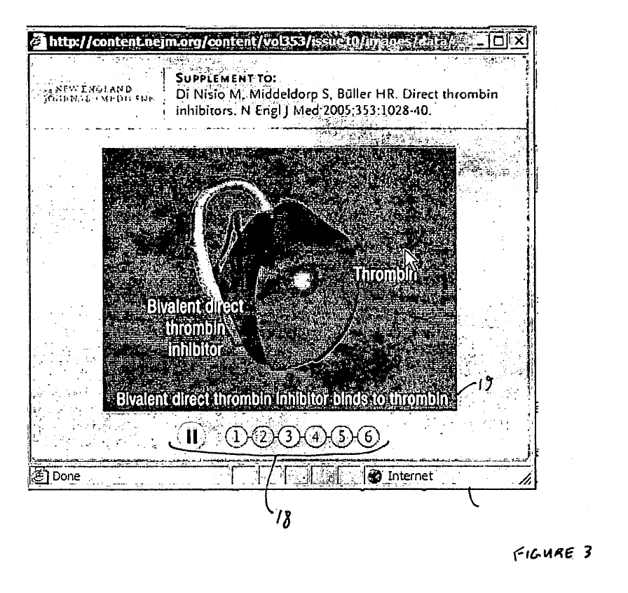

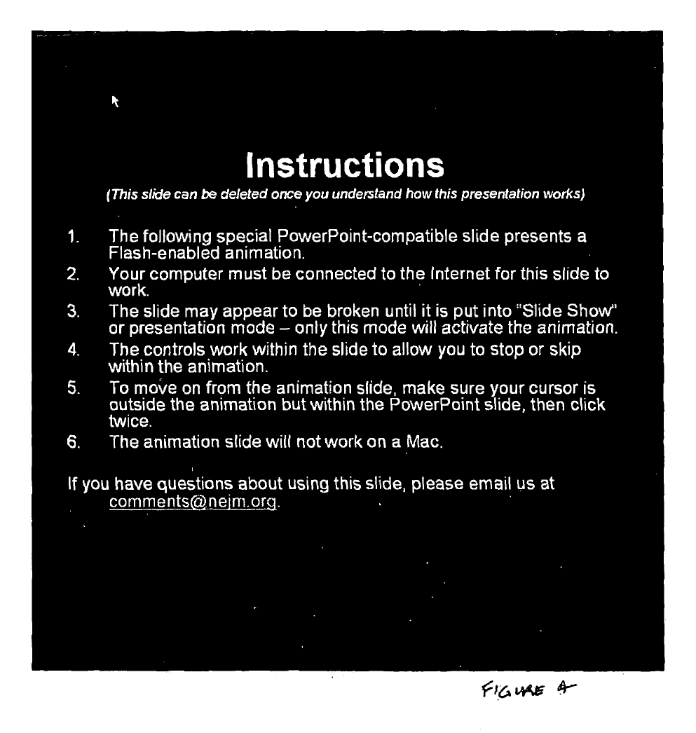

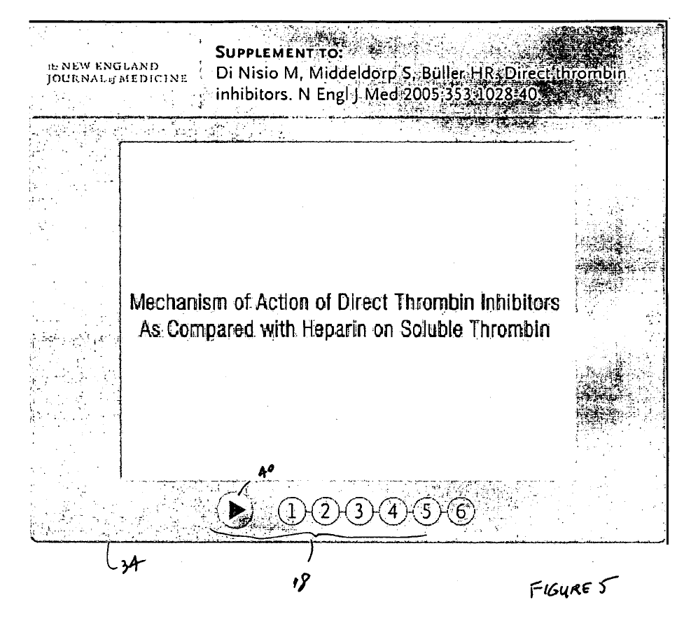

As shown in FIG. 1, a display on a web page 10 (for example, a web page that presents part of a scholarly journal article) may contain a static image 12 that is a placeholder for an animation. When the user clicks the image or a related link 14, a window 16 (FIG. 2) opens that contains an interactive control that either immediately begins to run the animation 19 (FIG. 3) for the user or permits the user to control the playing and replaying of the animation using navigation buttons 18 (FIG. 2). Thus, the animation is multimedia content that is presented through the interactive control within the presentation slide. Examples of such static images and the related animations may be seen on web pages of the website of the New England Journal of Medicine, at http://content.nejm.org/.

A user may wish to create his own local presentation (for example, a slide presentation in a format compatible with Microsoft PowerPoint) that uses text and images taken from the web pages of the journal article. A facility for enabling the user to convert such text or an image from the web page to an individual PowerPoint slide and download it to his local computer or other device has been available on the NEJM web site. The user may then include the slide in a PowerPoint presentation that he is manually generating locally.

As an improvement, the user may also click on a button 30 (FIG. 1) to receive at his local computer or other device a PowerPoint slide that contains an interactive control that enables the user to run essentially the same animation as shown in FIG. 3. The user may then include the slide in a PowerPoint presentation being created on his local computer.

When the user clicks button 30, he is presented the introductory screen shown in FIG. 4 which provides information about incorporating the animation in a PowerPoint presentation.

After viewing the screen of FIG. 4, the user may proceed to the next slide, for example, the screen of FIG. 5, which contains an image that looks like the slide shown in FIG. 2 and represents the animation to be incorporated into the user's PowerPoint presentation. The user can download and save a slide that corresponds to FIG. 5 on his local network or hard drive and incorporate the slide into the presentation.

When the resulting presentation is delivered as a slide show and the slide containing the slide of FIG. 5 is reached in the sequence, a related animation object is automatically called at a central server, and the animation is presented to the viewer. The presenter can then interactively control the display of the animation using the navigation buttons 18.

Navigation buttons 18 include a right arrow button 40 that starts the animation. The appearance of the button 40 then changes to the version shown in FIG. 3 to permit the presenter to stop the animation. The buttons numbered 1 through 6 display the state of progress (for example, in FIG. 3, the button marked 3 is highlighted) to show the viewer how far along the animation has proceeded. Each of the numbered buttons can be invoked to advance or move back in the animation to the point with which each button is associated.

Invoking the buttons triggers remote calls through the Internet to the central server where the animation object is stored. The server responds to the buttons as if the full animation object were stored on the presenter's local computer, although it is not.

In this example, to make use of the animation as part of a PowerPoint presentation, the local computer must be connected to the Internet and be able to invoke the central server during the presentation.

The slide for inclusion in the PowerPoint presentation can be automatically generated either during the process of producing the original website animation (in which case, the slide containing the animation is stored on the central server until needed by users who want to incorporate it into a PowerPoint presentation and downloaded as requested). Alternatively the slide can be generated dynamically at the time when a user invokes button 30 (FIG. 1).

At the central server, the animation object used in creation of the slide is described in one of two ways: in a stored structured mark-up language (for example, an XML control file using tags defined by an appropriate dtd or schema file), or as a real-time HTML packet for communication with the slide generator.

For the slide containing the animation to work at the local computer, information about the location of the animation object on the central server must be integrated into the presentation. Information about the animation object is provided in one of two ways: either stored as part of a central server database that contains XML code representing the journal article, or communicated on the network through a data packet sent in real-time to an application that can use this data packet to generate the slide's elements and features. In either case, the database at the central server includes citation metadata for the animation object (e.g., volume, issue, page, section_id), author metadata (e.g., first_name, last_name), and associated file metadata (e.g., view type and disk location). Not all of the information is needed to generate the slide for use at the local computer. The unneeded information is available for use in generating other configurations of the animation file for use in other ways.

For purposes of generating the slide for inclusion in the presentation, a Flash/slide configuration file (a control file) is defined to describe the source URI (unique resource identifier) of the animation object, its link to the original article, its size, and other characteristic information. An XML file that contains these elements of structured information is coupled with a pre-defined slide style template to create the final XML control file. This control file can be created at the time the Flash animation is generated, or dynamically composed on demand in response to requests for slides from users at local workstations based on a pre-defined schema. The schema contains parameters and can provide for multiple slides and multiple content types as needed to create a complete presentation. An example of a schema file is shown in FIG. 6. An example of a control file is shown in FIG. 7.

In some examples, the process for using the XML control file to generate the slide that contains the animation proceeds as follows:
1. Provide to the process that is generating the slide the location of the XML control file that contains the slide description information. The location may be a file system path to the file (if the process is within the same file system as the XML control file) or a URI if the XML control file is a network resource. Alternatively, the process obtains the path to the original article that contains reference to the animation file; then dynamically creates the XML control file by filtering article content.
2. Parse the XML control file to get a collection of slide descriptions.
3. Programmatically open the PowerPoint application, add a new slide for each item in the collection found in the XML control file. For each animation object, add appropriately shaped Flash objects to the slide as described in the XML control file.
4. Extract descriptive information about the animation from a corresponding segment of the XML control file. At a minimum, the following properties are required to be included in the XML segment: callout reference to a swf (Shockwave Flash) file, either identified as a local file path or as a URI; and size of the flash viewer expressed as width by height in pixels.
5. For a slide that is to contain a Flash animation, add a shape object that is of OLE type, in which to plug a Shockwave Flash ActiveX control. The scale of the shape is determined by the Flash viewer size called out in the XML segment.
6. Set up the presentation slide layout properties based on the pre-defined style template. This includes the background of the slide, its font color, and its font size.
7. Set up the properties of the Shockwave Flash ActiveX control using the information obtained from XML control file. Make sure the “Movie” link of the control points to the location of the swf file, and leave “EmbedMovie” to false. This will nest the control within the presentation, and cause it to make a call through the Internet to download and play the movie.
8. Save or export the generated PowerPoint file. This completes the process.

Other implementations are within the scope of the following claims.

Although the examples discussed above involve animations similar techniques apply to other multimedia content including audio and video.

As an alternative to the method of triggering the preparation of the slide to the one shown in FIG. 1, a form field format, such as the one shown in FIG. 8 may be displayed on the desktop or website and used to control the creation of the slide. The flash location box provides a place for the user to indicate the location at which the XML control file is found on the server. The save file as box is optional and enables the user to indicate where on the local workstation file system he wishes to save the completed slide. The Run PowerPoint button causes the slide to be generated and demonstrated. The Quit PowerPoint button stops the demonstration.

The process of requesting and creating the slide can be performed in other ways using applications running on other platforms and in other ways. For example, a generalized web-based application could be used.

1. A method comprising
creating an electronic presentation slide that, when presented at a first location, will provide multimedia content obtained during the presentation from a second location through a network.

2. The method of claim 1 in which the network comprises the Internet.

3. The method of claim 1 in which the multimedia content comprises an animation.

4. The method of claim 1 in which the second location comprises a central server.

5. The method of claim 1 in which the electronic presentation slide is in PowerPoint format.

6. The method of claim 1 in which the electronic presentation slide is created at the second location and delivered, to the first location for inclusion in a slide presentation.

7. The method of claim 1 in which the multimedia content is prepared for presentation prior to a time when the slide is presented at the first location.

8. The method of claim 1 in which the multimedia content is prepared for presentation dynamically in response to a request from the presentation slide, when the slide is being presented at the first location.

9. The method of claim 1 in which the electronic slide is prepared dynamically in response to a request from the user expressed in a form field interface.

10. The method of claim 1 in which creating the slide includes embedding information in the slide that enables a call to the multimedia content at the second location.

11. The method of claim 1 in which creating the slide includes inserting an active object in the slide.

12. The method of claim 1 in which the multimedia content is expressed in a Flash format.

13. The method of claim 1 in which the slide includes user interactive controls that are displayed and can be invoked by a user.

14. A method comprising
creating a PowerPoint slide that, when presented at a first location, will provide an animation obtained during the presentation from a second location through the Internet, the creating of the slide including insertion of an active object in the slide, the active object enabling a call to the multimedia content at the second location, the animation being expressed in Flash format, the slide including interactive features for controlling the animation.
